(19) United States
(12) Patent Application Publication
(10) Pub. No.: US 2013/0032237 A1
(43) Pub. Date: Feb. 7, 2013

(54) MOBILE COMPRESSED GAS DISPENSING DEVICE

(71) Applicants: Robert Adler, Gerasdorf (AT); Georg Siebert, Wien (AT); Markus Stephan, Vienna (AT); Markus Rasch, Vienna (AT)

(72) Inventors: Robert Adler, Gerasdorf (AT); Georg Siebert, Wien (AT); Markus Stephan, Vienna (AT); Markus Rasch, Vienna (AT)

(21) Appl. No.: 13/332,803

(22) Filed: Dec. 21, 2011

(30) Foreign Application Priority Data
Jan. 27, 2011 (DE) 102011009581.0

(51) Int. Cl. B60P 3/22; F04B 17/06

(52) U.S. Cl. 137/899.4

(57) ABSTRACT

A mobile compressed gas dispensing device, in particular a mobile hydrogen filling station, which is transported by means of a vehicle is disclosed. The device contains a drive unit, which serves to drive the vehicle, which transports the compressed gas dispensing device; at least one storage container, which is suitable for storing a compressed medium; at least one line, via which the storage container or the storage containers, respectively, can be connected to an external storage container, which is to be filled by the compressed gas dispensing device, and at least one compressor. The compressor is operatively connected to the drive unit of the vehicle in such a manner that it can be driven by said drive unit.

### CROSS REFERENCE TO RELATED APPLICATIONS

This application claims priority from German Patent Application DE 102011009581.0 filed Jan. 27, 2011.

### BACKGROUND OF THE INVENTION

The invention relates to a mobile compressed gas dispensing device, in particular a mobile hydrogen filling station, which is transported by means of a vehicle, comprising
a drive unit, which serves to drive the vehicle, which transports the compressed gas dispensing device,
at least one storage container, which is suitable for storing a compressed medium,
at least one line, via which the storage container or the storage containers, respectively, can be connected to an external storage container, which is to be filled by the compressed gas dispensing device, and
at least one compressor.

Hereinbelow, the term “vehicle” is to be understood as referring to all kinds or types, respectively, of landcrafts, aircrafts and watercrafts, by means of which a compressed gas dispensing device can be transported.

First fleet tests with hydrogen-operated cars have been going on for some time. The fill-up of these cars is hereby either carried out at stationary hydrogen filling stations—their number, however, is manageable so far—as well as by means of mobile hydrogen filling stations. These mobile hydrogen filling stations are currently transported to their location of application or set-up, respectively, by means of trucks. Typically, such mobile hydrogen filing stations encompass one or a plurality of hydrogen storage containers, a compressor, a line or coupling system, by means of which they can be connected to a car, which is to be filled, as well as a compressor, which serves to compress the hydrogen, which is conveyed into the car, which is to be filled.

Typically, such a hydrogen filling station is connected to the available infrastructure (electricity network, water supply network, etc.) at its set-up locations. In the alternative, the mobile hydrogen filling station or the vehicle transporting it, respectively, can additionally encompass at least one generator, which generates the current required for operating the compressed gas dispensing device or hydrogen filling station, respectively. On principle, this alternative does not require any external infrastructure. However, it requires a large amount of space and thus possibly a larger transport vehicle. In the case of this alternative, the separation between the generator or supply system, respectively, and the so-called ex area is additionally only possible when a sufficient distance between the individual components (vehicle size) or a gas-tight separation (added weight) are or can be realized.

On principle, a so-called high-pressure storage system can also be realized, in the case of which the hydrogen is stored in the storage container or in the storage containers, respectively, under a comparatively high pressure and a compressor is thus not required for filling a car, which is to be filled. This alternative, however, has the disadvantage that the storage containers can only be refilled at suitable locations. In addition, the storage container or the storage containers, respectively, is/are discharged after a plurality of filling processes and can consequently dispense hydrogen into the storage container, which is to be filled, or into the car, which is to be filled, respectively, only to the respectively current storage pressure.

### SUMMARY OF THE INVENTION

It is the object of the instant invention to specify a generic compressed gas dispensing device, in particular a mobile hydrogen filling station, which is suitable for dispensing compressed hydrogen, which avoids the afore-mentioned disadvantage and which, in particular, does not require an external infrastructure.

To solve this object, a generic compressed gas dispensing device is proposed, which is characterized in that the compressor or at least one of the compressors is operatively connected to the drive unit of the vehicle in such a manner that it can be driven by said drive unit.

### DETAILED DESCRIPTION OF THE INVENTION

Further advantageous embodiments of the mobile compressed gas delivery device according to the invention, which represent subject matters of the dependent patent claims, are characterized in that
the auxiliary system or at least one of the auxiliary systems are operatively connected to the drive unit of the vehicle in such a manner that it can be driven and/or be supplied with energy by said drive unit, provided that provision is additionally made for at least one energy-consuming auxiliary system,
the operative connection between compressor and drive unit and/or the operative connection between compressor and auxiliary system is realized in the form of one hydraulic drive or a plurality of hydraulic drives,
the operative connection between compressor and drive unit and/or the operative connection between compressor and auxiliary system is realized in the form of one or a plurality of positive, frictionally engaged and/or non-positive connection/connections,
provision is made for at least one generator, and said generator is operatively connected to the drive unit in such a manner that it can be driven by said drive unit, and
the cooling system is embodied in such a manner that it at least temporarily cools the compressed gas, which is dispensed from the compressed gas dispensing device, provided that the vehicle, which transports the compressed gas dispensing device, encompasses a cooling system.

According to the invention, the drive unit of the towing or transport vehicle, respectively, is now used to supply the compressor with energy. Preferably, the connection of the drive unit to the compressor is hereby carried out via an (auxiliary) hydraulic system. This system is connected to the drive unit and can be switched on by the driver or operator, respectively, of the compressed gas dispensing device according to the invention. The control of the connected systems is preferably carried out by means of the vehicle electronics, which is adapted accordingly—in particular in view of the required energy quantity.

Preferably, the drive of the compressor is carried out via a hydraulic motor. Such motors have the necessary torque to be able to drive the compressor. The regulation of the energy consumption of the compressor can be carried out via the hydraulic quantity, which reaches the hydraulic motor. The regulation is hereby either carried out by means of a swing pump on the auxiliary drive or other flow-related control variables. In this manner, it is ensured that the drive unit can generate the energy required for the operation of the compressor. In response to the use of a hydraulic system, it is additionally ensured that the energy supply is securely separated from the afore-mentioned ex area. The connection between drive unit and compressor drive is only carried out via the line system, which is filled with hydraulic oil. The medium, which is to be compressed, or the hydrogen, which is to be compressed, respectively, has the opportunity to penetrate into this system, because it is under a sufficiently high pressure.

Depending on the design, generic compressed gas dispensing devices encompass additional energy-consuming auxiliary systems, such as water pumps, cooling air fans, air compressors, etc., for example. In an advantageous manner, such auxiliary systems are also connected to the drive unit in such a manner that they can be driven by it and/or that they can be supplied with energy by it. In an advantageous manner, this connection between drive unit and auxiliary system is also carried out by means of a hydraulic drive.

The control of the compressed gas dispensing device, which is transported by means of the vehicle, or the provision of the energy required for the control, respectively, is also carried out via the drive unit of the vehicle. For this purpose, the drive unit as well as the generator assigned to it, which supplies the electrical system of the vehicle with current, must be dimensioned accordingly.

In addition to this or in the alternative, provision can be made for an additional generator, which is preferably also operatively connected to the drive unit via a hydraulic drive.

A basic problem in the case of generic mobile compressed gas dispensing devices is the changing ambient conditions, in particular the changing ambient temperature. The hydrogen, which must be supplied to a vehicle, which is to be filled, must furthermore typically be cooled prior to flowing into the storage container of the vehicle, which is to be filled. Advantageously, the energy required for this is provided by the cooling system of the vehicle, which transports the compressed gas dispensing device. Even though the additional heat exchanger, which is necessary for cooling the compressed gas or hydrogen, respectively, makes the cooling system of the vehicle more expensive and more complicated, but a cooling system, which must be provided externally and to which the compressed gas dispensing device would otherwise have to be connected, is not necessary.

As compared to the state of the art explained above, the mobile compressed gas dispensing device according to the invention has the advantage that it can be operated independent on the infrastructure, which is available at the location of application. After arrival at the location of application, it is thus also ready for operation more quickly, because the connection work, which was previously required, is completely unnecessary.

What we claim is:

1. A mobile compressed gas dispensing device, which is transported by means of a vehicle, comprising:
a drive unit, which serves to drive the vehicle, which transports the compressed gas dispensing device;
at least one storage container, which is suitable for storing a compressed medium;
at least one line, via which the storage container or the storage containers, respectively, can be connected to an external storage container, which is to be filled by the compressed gas dispensing device; and
at least one compressor,
characterized in that said at least one of compressor is operatively connected to the drive unit of the vehicle in such a manner that it can be driven by said drive unit.

2. The mobile compressed gas dispensing device according to claim 1, which is a mobile hydrogen filling station.

3. The mobile compressed gas dispensing device according to claim 1, wherein provision is additionally made for at least one energy-consuming auxiliary system, characterized in that the auxiliary system or at least one of the auxiliary systems are operatively connected to the drive unit in such a manner that it can be driven and/or be supplied with energy by said drive system.

4. The mobile compressed gas dispensing device according to claim 1, characterized in that the operative connection between compressor and drive unit and/or the operative connection between compressor and auxiliary system is realized in the form of one hydraulic drive or a plurality of hydraulic drives.

5. The mobile compressed gas dispensing device according to claim 1, characterized in that the operative connection between compressor and drive unit and/or the operative connection between compressor and auxiliary system is realized in the form of one or a plurality of positive, frictionally engaged and/or non-positive connection/connections

6. The mobile compressed gas dispensing device according to claim 1, characterized in that provision is made for at least one generator and that this generator is operatively connected to the drive unit in such a manner that it can be driven by said drive unit.

7. The mobile compressed gas dispensing device claim 1, wherein the vehicle, which transports the compressed gas dispensing device, encompasses a cooling system, characterized in that the cooling system is embodied in such a manner that it at least temporarily cools the compressed gas, which is dispensed from the compressed gas dispensing device.
